(19) United States
(12) Patent Application Publication
(10) Pub. No.: US 2006/0290219 A1
(43) Pub. Date: Dec. 28, 2006

(54) Electric machine with permanent magnetic rotor

(76) Inventors: David Rodger, Bath (GB); Hong Cheng Lai, Bath (GB); John Roger Hill-Cottingham, Radstock (GB)

Correspondence Address: JORDAN AND HAMBURG LLP, 122 EAST 42ND STREET, SUITE 4000, NEW YORK, NY, 10168, US

(21) Appl. No.: 10/558,908

(22) PCT Filed: May 28, 2004
(86) PCT No.: PCT/GB04/02313

§ 371 Date: Jan. 12, 2006

(30) Foreign Application Priority Data
May 30, 2003 (GB) 0312486.4

(51) Int. Cl. H02K 21/12; H02K 11/00

(52) U.S. Cl. 310/156.36; 310/68 R

(57) ABSTRACT

An electric motor (10) comprises a stator (20) having a primary winding and a rotor (130a,b) arranged to rotate in the stator (20). The rotor comprises a shaft (160), a first magnetic rotor component (140) and a second magnetic rotor component (150), each magnetic rotor component (140,150) having a magnetic pole of a first polarity (43,43′,53,53′) and a magnetic pole of a second polarity (47,47′,57,57′). At least one of the first and second rotor components (140,150) further comprises a structure (35) for carrying induced eddy currents. The second magnetic rotor component (150) is rotatable with respect to the first magnetic rotor component (140) around the shaft (160) from a low-flux orientation to a high-flux orientation. The motor (10) is arranged such that the second magnetic rotor component (150) is in the low-flux orientation when the rotor (130a,b) is at rest and is in the high-flux orientation when the rotor (130a,b) is rotating at an operating speed.

### BACKGROUND OF THE INVENTION

This invention relates to electromotive machines, in particular to electric motors and generators.

U.S. Pat. No. 5,821,710 describes a synchronous motor that includes a rotor having field permanent magnets comprising a first field-permanent magnet and a second field-permanent magnet that is adapted to be rotatable with respect to the first field-permanent magnet. The rotor magnets are aligned to give a strong magnetic field during low-speed rotation to yield high torque and misaligned to give a weaker magnetic field during high-speed rotation.

The inventors have realised that a rotor having a first field-permanent magnet that can be rotated relative to a second field permanent magnet has an important new application in line-start hybrid permanent magnet induction-motor technology. The inventors have also realised that such a rotor has an application in generator technology.

An object of the invention is to provide an improved electric motor, which can readily be started from rest and run synchronously more efficiently than prior-art line-start hybrid permanent magnet induction motors. Another object of the invention is to provide an electric generator with the means to reduce the field to prevent damage to the machine if a short circuit occurs in the stator.

Synchronous motors, which comprise a rotor with permanent magnets, are relatively difficult to start compared with induction motors. In contrast, induction motors, which comprise a rotor with a winding or cage, are relatively easy to start but run relatively inefficiently compared with permanent-magnet field-synchronous motors.

Hybrid permanent-magnet induction motors are known in the prior art; the rotor of such a motor comprises both a permanent magnet and a cage or winding. However, the design of such motors involves a compromise between the preference for no magnets to obtain high torque starting and strong magnets to obtain high torque at operating speed.

### SUMMARY OF THE INVENTION

According to the invention there is provided an electric motor comprising: a stator having a primary winding; a rotor arranged to rotate in the stator and comprising a shaft, a first magnetic rotor component and a second magnetic rotor component, each magnetic rotor component having a magnetic pole of a first polarity and a magnetic pole of a second polarity, at least one of the first and second rotor components further comprising a structure for carrying induced eddy currents, the second magnetic rotor component being rotatable with respect to the first magnetic rotor component around the shaft from an low-flux orientation to an high-flux orientation, the motor being arranged such that the second magnetic rotor component is in the low-flux orientation when the rotor is at rest and is in the high-flux orientation when the rotor is rotating at an operating speed.

The invention thus provides a permanent-magnet line-start induction-synchronous motor. An electric motor according to the invention, will behave as an induction motor (which is easier to start than a synchronous motor) when the magnetic rotor components are in the low-flux orientation, so that their magnetic field is partially or completely cancelled, and as a permanent-magnet synchronous motor (which is more efficent than an induction motor) when the magnetic rotor components are in the high-flux orientation. The invention thus provides a mechanical method of reducing or cancelling the field from the first and second magnetic rotor components which enables the machine to start as a plain induction motor.

Such a device may enable the fitment or retro-fitment of high efficiency machines in a wide range of installations without the need for a variable-frequency supply. The invention may be used to raise the efficiency of an induction motor installation. The higher efficiency operation compared with prior art devices may help users to meet their energy-efficiency targets.

The structure for carrying induced eddy currents may be for example a cage, a rotor winding, an iron cylinder or a conducting sheet mounted on a cylinder; suitable structures are well known prior art. The first and second magnetic rotor components may both comprise a structure for carrying induced eddy currents.

The first and second magnetic rotor components and stator may be arranged so that the dominant direction of magnetic flux across the airgap between stator and magnetic rotor components is radial with respect to the shaft, or the first and second magnetic rotor components and stator may be arranged so that the dominant direction of magnetic flux across the airgap between the first and second magnetic rotor components and stator is axial with respect to the shaft.

In the radial-flux arrangement, the magnetic pole of the first polarity of the first rotor component may make an angle of less than 45 electromagnetic with the magnetic pole of the first polarity of the second rotor component in the high-flux orientation; that angle is preferably less than 30, less than 10 electromagnetic, less than 5 electromagnetic or more preferably less than 1 electromagnetic. The magnetic pole of the first polarity of the first rotor component may then make an angle of less than 45 electromagnetic with the magnetic pole of the second polarity of the second rotor component in the low-flux orientation; that angle is preferably less than 30, less than 10 electromagnetic, less than 5 electromagnetic or more preferably less than 1 electromagnetic.

In the axial-flux arrangement, the magnetic pole of the first polarity of the first rotor component may make an angle of less than 45 electromagnetic with the magnetic pole of the second polarity of the second rotor component in the high-flux orientation; that angle is preferably less than 30, less than 10 electromagnetic, less than 5 electromagnetic or more preferably less than 1 electromagnetic. The magnetic pole of the first polarity of the first rotor component may then make an angle of less than 45 electromagnetic with the magnetic pole of the first polarity of the second rotor component in the low-flux orientation; that angle is preferably less than 30, less than 10 electromagnetic, less than 5 electromagnetic or more preferably less than 1 electromagnetic.

The magnetic field due to the first and second magnetic rotor components may thus be changed, in either arrangement, from low or substantially zero (with the fields due to the separate magnetic rotor components partially or completely cancelling in the low-flux orientation) to a maximum (with the fields due to the separate magnetic rotor components acting together in the high-flux orientation).

The electromotive machine may be arranged such that the second magnetic rotor component is in the high-flux orientation when the rotor reaches an operating speed.

The second magnetic rotor component may be arrestable at an orientation relative to the first magnetic rotor component that is between the low-flux orientation and the high-flux orientation. The magnetic field due to the first and second magnetic rotor components may thus be controlled by arresting the second magnetic rotor component at some intermediate orientation, at which its field partially cancels that of the first magnetic rotor component.

The second magnetic rotor component may be rotated or locked in position relative to the first magnetic rotor component by a centrifugal device. The centrifugal device may take any suitable form. For example, the centrifugal device may comprise a latch mounted in a fixed position relative to the first or second magnetic rotor component and a groove situated in a fixed position relative to the other magnetic rotor component, the centrifugal device further comprising an inner slot communicating with an inner edge of the groove and an outer slot communicating with an outer edge of the groove, the inner and outer slots being displaced circumferentially from each other and being arranged to receive the latch, the centrifugal device being arranged such that the latch locks the second magnetic rotor component in the low-flux position at starting and at a predetermined speed the latch moves between the inner slot and the outer slot as the rotor changes its velocity and the circumferential movement of the latch rotates the second magnetic rotor component and locks it relative to the first magnetic rotor component in the high-flux position.

Alternatively, the second magnetic rotor component may be rotated relative to the first magnetic rotor component by any other suitable means, for example by a control (or pilot) motor.

The second magnetic rotor component may be rotated relative to the first magnetic rotor component when the rotor reaches a selected angular speed. The selected speed may for example be a predetermined fixed speed or a speed selected in response to a sensed condition. The speed may thus for example be a continuously variable angular speed, selection of which may be controlled automatically. The second magnetic rotor component may be rotated relative to the first magnetic rotor component by an amount that is variable in response to a sensed condition. The first and second rotor components may continuously change their relative orientation in response to the sensed condition.

The first magnetic rotor component may be fixed to the shaft of the rotor and the second magnetic rotor component may rotate relative to the shaft.

Alternatively, the second magnetic rotor component may be fixed to the shaft of the rotor and the first magnetic rotor component may rotate relative to the shaft.

The first magnetic rotor component or the second magnetic rotor component may comprise a plurality of poles of the first polarity and a plurality of poles of the second polarity, which will of course be sequentially arranged in a rotating direction. The first and the second magnetic rotor component may each comprise a plurality of poles of the first polarity and a plurality of poles of the second polarity.

In the radial magnetic flux arrangement, the first magnetic rotor component may be arranged axially adjacent to the second magnetic rotor component. The first magnetic rotor component may at least partially overlap with the second magnetic rotor component or those rotor components may be axially separate.

The motor may be supplied by a multi-phase electricity supply such as a three-phase supply.

The motor may be supplied by a single-phase electricity supply.

Also according to the invention there is provided a machine including such an electric motor.

Also according to the invention there is provided a method of operating an electric motor, comprising:

operating a stator having a primary winding and a rotor arranged to rotate in the stator and comprising a shaft and a first magnetic rotor component and a second magnetic rotor component, each magnetic rotor component having a magnetic pole of a first polarity and a magnetic pole of a second polarity and at least one of the first or second rotor components comprising a structure for carrying induced eddy currents, the operation comprising rotating the second magnetic rotor component around the shaft relative to the first magnetic rotor component from an low-flux orientation to an high-flux orientation, such that the second magnetic rotor component is in the low-flux orientation when the rotor is at rest relative to the stator and is in the high-flux orientation when the rotor is rotating at an operating speed.

The method enables permanent-magnet line-start induction/synchronous motors to start in plain induction mode and then synchronize once started, enabling higher efficiencies once running and reduced energy consumption.

The second magnetic rotor component may be rotated to the high-flux orientation when the rotor reaches a selected angular speed relative to the stator.

The second magnetic rotor component may be rotated to and arrested at an orientation relative to the first magnetic rotor component that is between the low-flux orientation and the high-flux orientation in which the pole of the first polarity of the second magnetic rotor component is aligned with a pole of the first polarity of the first magnetic rotor component.

In the method of operating an electric motor, the second magnetic rotor component may be rotated to provide an electric motor with field control so as to vary the supply voltage requirements of the motor. Prior-art DC motors provide easily variable output powers but have the disadvantage that parts such as brushes suffer significant mechanical wear. Variable output powers in prior art AC motors require implementation by expensive power electronics. The invention advantageously provides a relatively inexpensive means of providing variable output power from an AC motor.

Also according to the invention there is provided an electromotive machine comprising: a stator; a rotor arranged to rotate in the stator and comprising a first magnetic rotor component having a pole of a first polarity and a pole of a second polarity and a second magnetic rotor component having a pole of the first polarity and a pole of the second polarity, the second magnetic rotor component being rotatable with respect to the first magnetic rotor component.

Also according to the invention there is provided a method of operating an electromotive machine, comprising: providing a stator and a rotor arranged to rotate in the stator and comprising a first magnetic rotor component having a pole of a first polarity and a pole of a second polarity and a second magnetic rotor component having a pole of the first polarity and a pole of the second polarity; and rotating the second magnetic rotor component relative to the first magnetic rotor component.

It will be apparent to the skilled person that many of the features described above, with regard to electric motors according to the invention, are also applicable to electric generators.

A problem in a permanent magnet generator is that the field cannot be turned off if there is a fault, such as for instance a short circuit in the stator winding. If the source of mechanical power cannot be turned off quickly then a dangerous situation can result. According to a second aspect of the invention there is provided a method of turning off the field of an electromotive machine by rotating a second magnetic rotor component having a pole of a first polarity and a pole of a second polarity relative to a first magnetic rotor component having a pole of the first polarity and a pole of the second polarity. Preferably, the electromotive machine is turned off in response to a fault. Preferably, the electromotive machine is a generator.

### BRIEF DESCRIPTION OF THE DRAWINGS

By way of example only, embodiments of the invention will now be described, with reference to the accompanying drawings, of which:

FIG. 1 is a rotor including magnetic rotor components in an low-flux orientation;

FIG. 2 is a rotor including magnetic rotor components in an high-flux orientation;

FIG. 3 is a line drawing of a partial, disassembled rotor;

FIG. 4 is a line drawing of part of a centrifugal latch device used in the rotor of FIG. 3;

FIG. 5 is a groove plate, forming another part of the centrifugal latch device of FIG. 4;

FIG. 6 is a schematic of a radial flux motor and generator according to the invention.

FIG. 7 is a schematic of an axial flux motor and generator according to the invention.

FIG. 8 is a schematic of an alternative embodiment of the invention, in which rotation of a magnetic rotor component is controlled by a control motor.

### DETAILED DESCRIPTION OF THE INVENTION

The electromotive apparatus 10 of FIG. 6 comprises a stator 20 and a rotor 30. As is well known, when electromotive apparatus is operating as a motor, electric power is supplied to the stator to provide a rotating magnetic field in a manner well known in the art. The rotating stator field rotates the rotor to produce useful work. When the apparatus is operating as a generator, the rotor is rotated by an external source of mechanical power and electrical power is generated in the stator.

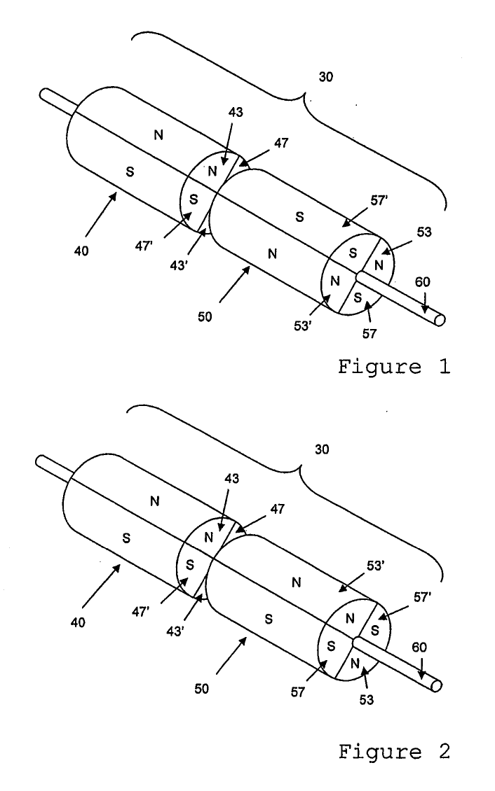

In the embodiment of FIG. 6, in summary, the rotor 30 utilises normal squirrel-cage construction but with buried permanent magnets or with surface mounted magnets. The rotor is split into two parts; one fixed permanently to the shaft, the other axially fixed but allowed to rotate on the shaft through a limited angle of 180 degrees electro-magnetic. At standstill, a mechanism is used to hold the two parts of the rotor at 180 degrees electromagnetic with respect to each other (FIG. 1); that means that the magnetic field from the permanent magnets 40,50 will tend to cancel.

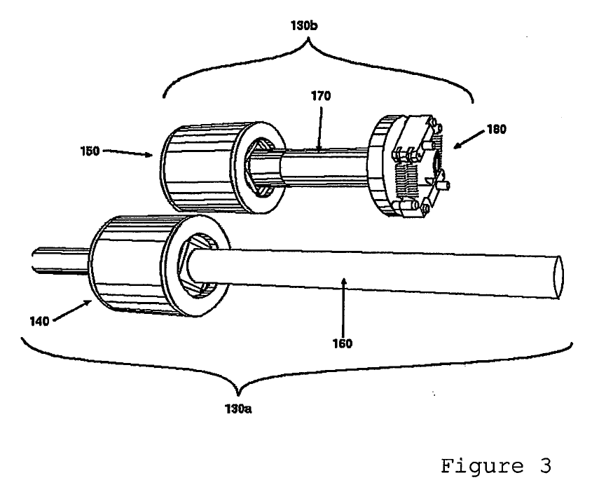

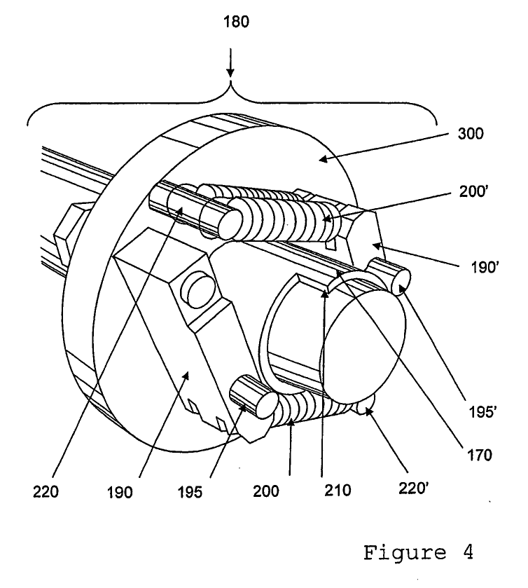

Thus when the stator 20 is energised, the machine behaves as an ordinary induction motor and starts in the usual way. At some speed less than synchronous speed, a mechanism releases the moving rotor part, which then experiences positive and negative torques due to its permanent magnets interacting with the rotating stator field and positive torques due to the currents induced in the cage by the rotating stator field. Because of the moving rotor part's relatively low inertia, the stator field will move it rotationally with respect to the fixed rotor part. When the rotor 30 has moved to the high-flux position, (FIG. 2) the mechanism will lock its position with respect to the fixed rotor part. The machine will now behave as a permanent-magnet synchronous machine, and synchronise to the stator travelling field in the normal way. The mechanism may be integrated in the machine or external to the main housing (for example as in FIGS. 3 and 4); it may be operated automatically (for example centrifugally) or by some external control.

In an alternative embodiment, the magnet-rotation mechanism may be used to control the net excitation of the machine from near zero to full excitation by varying (using, for example, a control motor) the relative positions of the two rotor parts, over 0 to 180 degrees electromagnetic, i.e. to positions between the positions shown in FIGS. 1 and 2.

Describing now the example embodiments in more detail, in the apparatus 10 of FIG. 6, rotor 30 comprises a structure for carrying induced eddy currents, in the form of a squirrel cage 35, of a type well known in the art, inside which are provided a pair of magnet assemblies or magnetic rotor components 40,50 mounted on a shaft 60 (FIGS. 1 and 2; for clarity of illustration, the squirrel cage 35 is not shown). Each rotor component 40,50 comprises two north poles 43,43′, 53, 53′ and two south poles 47,47′, 57,57′, arranged such that like poles within each rotor component are arranged on opposite sides of the shaft 60. The rotor components 40,50 are substantially cylindrical and contain permanent-magnet material, which may be surface mounted on the cylinder or buried within the cylinder in a manner well known in the art.

First magnetic rotor component 40 is fixed to the shaft 60. Second magnetic rotor component 50 is fixed in its axial position relative to the shaft 60 but is free to rotate about the shaft 60. In particular, it may be rotated from an anti-aligned′, low-flux orientation, in which the north poles 43, 43′ of the first rotor component are aligned with the south poles 57, 57′ of the-second rotor component (and hence the south poles 47, 47′ with the north poles 53, 53′—FIG. 1) to an aligned′, high-flux orientation, in which the north poles 43, 43′ of the first rotor component are aligned with the north poles 53, 53′ of the second rotor component (and hence the south poles 47, 47′ with the south poles 57,57′—FIG. 2).

When the apparatus 10 is operated as a motor, magnetic rotor components 40,50 are initially in the anti-aligned orientation, as shown in FIG. 1. As the poles 43, 43′, 53, 53′, 47, 47′, 57, 57′ are anti-aligned, the magnetic fields produced by magnetic rotor components 40,50 substantially cancel, and the rotor 30 behaves as if it is substantially magnetically neutral. The motor 10 then behaves as if it is a simple induction motor. In particular, start-up and initial run-up of the motor can readily be achieved by induction, which is not always possible in a simple synchronous motor having fixed rotor magnets.

When the rotor reaches a predetermined angular speed, second rotor component 50 is rotated relative to rotor component 40 to the high-flux orientation. In this arrangement, rotor components 40, 50 effectively act as a single large magnet. The motor 10 then behaves as if it is a simple synchronous motor. In particular, its normal running operation is significantly more efficient than that of a simple induction motor having no rotor magnets. The motor 10 is also significantly easier to start than a prior art line-start hybrid permanent magnet induction motor, which will generally have magnets of a size chosen as a compromise between the preference for no magnets at start-up and strong magnets at full speed.

In the low-flux orientation, the net magnetic flux per pole passing from the first and second rotor components through the stator is relatively low and in the high-flux orientation, the net magnetic flux per pole passing from the first and second rotor components through the stator is relatively high. The net flux per pole is the integral of all the magnetic field, the integral being taken over one pole of the machine.

Motor 10 may also be used to provide a variable power output. By rotating magnetic rotor component 50 relative to magnetic rotor component 40 to orientations between the anti-aligned and aligned orientations of FIGS. 1 and 2 respectively, the degree of coupling between the rotor and stator may be controlled.

Similarly, when apparatus 10 is run as a generator, by rotating the magnetic rotor component 50, the excitation of the stator 20 by the rotating rotor 30 can be varied.

We have built a working prototype of an embodiment of the invention. Parts of the prototype relevant to the invention are shown in FIGS. 3 to 5.

The rotor 130a, b is shown in FIG. 3. It comprises an shaft 160 and a sleeve 170 that is arranged to fit over the shaft 160. First magnetic rotor component 140 is fixed to shaft 160. Second magnetic rotor component 150 is attached to sleeve 170. Second magnetic rotor component 150 is rotated relative to first magnetic rotor component 160 by means of centrifugal switch 180.

(NB: switch 180 is provided external to magnetic rotor component 150 for ease of access in our prototype. In alternative embodiments, switch 180 may be arranged within magnetic rotor component 150, with sleeve 170 being made correspondingly short.)

Part of centrifugal switch 180 is shown in more detail in FIG. 4. Switch 180 comprises face plate 300, which is fixed to sleeve 170. Latches 190, 190′ are each pivotally attached at a proximal end to plate 300 near the plate's circumference, with latch 190 pivoted at a point on the opposite side of sleeve 170 from latch 190′. The distal ends of latches 190, 190′ are biased towards sleeve 170 by springs 200,200′, which are anchored by pins 220, 220′. Each latch 190, 190′ carries a pin 195,195′.

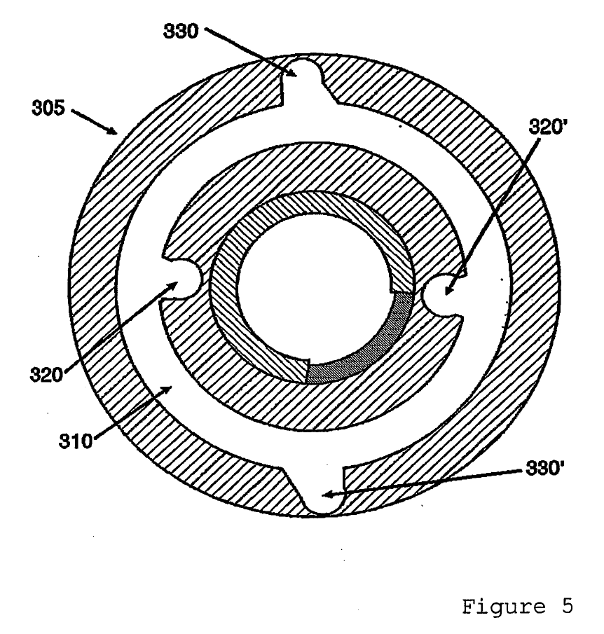

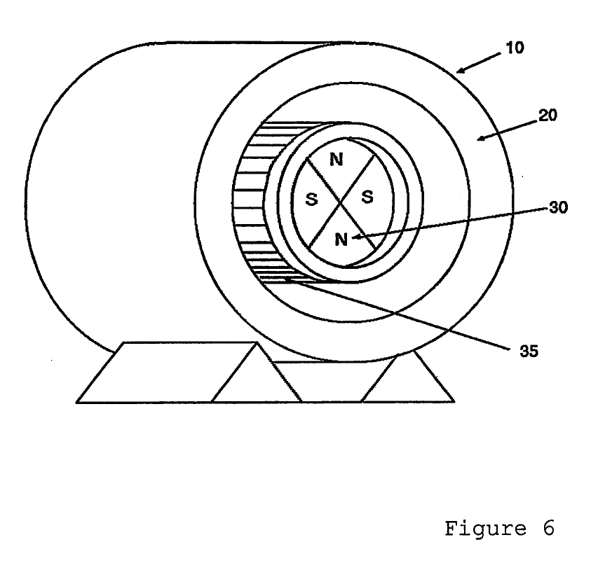

Face plate 300 engages with groove plate 305 (FIG. 5), which is fixed to shaft 160. Groove plate 305 includes annular groove 310, inner slots 320, 320′ and outer slots 330,330′. Inner slots 320, 320′ communicate with the inner side wall of groove 310 and outer slots communicate with the outer side wall of groove 310. Inner slot 320 is arranged on the opposite side of shaft 160 from inner slot 320′ and outer slot 330 is arranged on the opposite side of shaft 160 from outer slot 330′. Inner slots 320, 320′ are arranged on a line that in our prototype makes an angle of 83 degrees with a line through outer slots 330,330′.

In use as an induction motor, pins 195, 195′ are engaged in slots 320, 320′ respectively when rotor 130a,b is at rest. As rotor 130a,b begins to rotate, latch 190,190′ experiences a centrifugal effect which urges it radially outwards. At a predetermined angular speed (in our prototype, which has an operating speed of about 1500 rpm, the predetermined angular speed is about 1400 rpm), pins 195, 195′ are released from slots 320,320′. As the rotor sleeve assembly 130b has a relatively low inertia, it will rotate relative to the rotor shaft assembly 130a. Pins 195, 195′ are guided in groove 310. The rotor sleeve assembly rotates until, when the parallel orientation of FIG. 2 is reached, the sleeve's rotation is halted by edge 210 on face plate 300. Pins 195, 195′ then engage with outer slots 330,330′.

In an alternative embodiment of the invention (FIG. 8), centrifugal switch 180 is replaced with a-control motor 502 that rotates second magnetic rotor component 505 when rotor 500 reaches a predetermined angular speed. A centrifugal switch such as that described above is expected to be particularly suitable for use in a relatively low-cost motor or generator, in which the cost of a control motor would be a significant fraction of the total cost. It is expected that in higher-cost devices, in which the cost of a control motor would be relatively insignificant, use of a control motor would be preferred, although of course any suitable mechanism may be used.

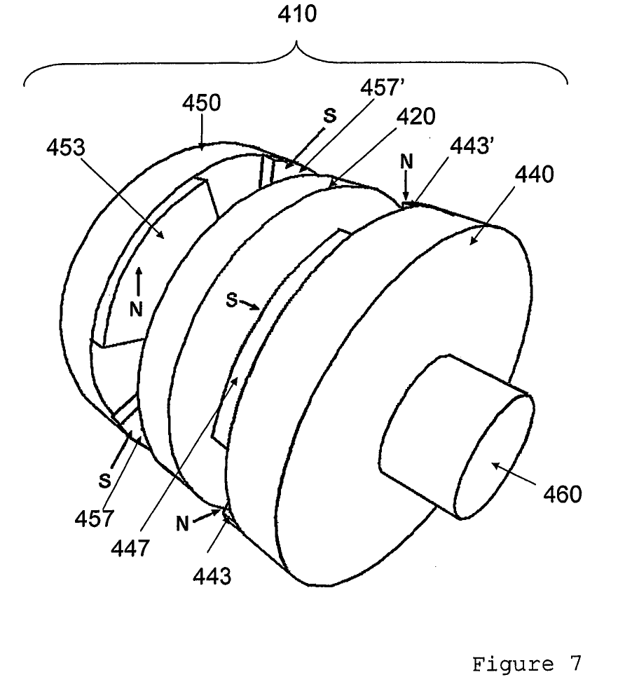

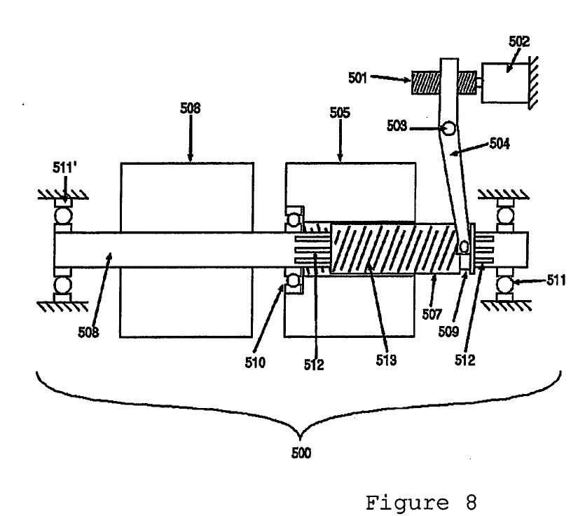

An axial-magnetic-flux embodiment of the invention is shown schematically in FIG. 7. Magnetic rotor component 440 is fitted with a conducting cage or winding and also with two surface-mounted magnets 443, 443′ having their north poles at the surface of the rotor component and two surface-mounted magnets 447, (second not visible in FIG. 7) having their south poles at the surface of the rotor component 440.

Similarly, magnetic rotor component 450 is fitted with a conducting cage or winding and also with two surface-mounted magnets 453, (second not visible in FIG. 7) having their north poles at the surface of the rotor component and two surface-mounted magnets 457, 457′ having their south poles at the surface of the rotor component 450. (Alternatively, rotor component 440 or 450 may have buried permanent magnets.) Flux passing between the magnetic poles of rotor component 440 and the magnetic poles of rotor component 450 runs parallel to the axis 460 where the flux interacts with the stator 420.

First magnetic rotor component 440 is fixed to the shaft 460. Second magnetic rotor component 450 is fixed in its axial position relative to the shaft 460 but is free to rotate about the shaft 460 to an low-flux or aligned position relative to the first magnetic rotor component. Stator 420 has a bigger hole in it than rotor components 440,450, so that it clears the shaft completely. The methods for rotating and latching are in this embodiment the same as for the radial magnetic flux embodiment of FIG. 6. In an alternative embodiment, another mechanism such as a control motor is used.

The axial-flux machine is shown in its high-flux position in FIG. 7, with the north poles of rotor component 450 opposite the south poles of rotor component 440; in the low-flux position, the north poles of rotor component 450 are opposite the north poles of rotor component 440 (that is of course the opposite way round to the radial-flux machine shown in FIGS. 1 and 2).

In an alternative embodiment (FIG. 8), a control motor is used to move a magnetic rotor component to any angle between fully aligned and fully anti-aligned positions. Control motor 502 rotates a lead screw mechanism 501 which moves lever arm 504 about pivot 503. The end of the lever arm 504 is attached to a moving thrust sleeve 507 via a thrust bearing 509. The thrust bearing 509 allows thrust sleeve 507 to rotate with respect to the lever arm 504 but holds thrust sleeve 507 in an axial position. Thrust sleeve 507 is cylindrical and has splines cut on the inside surface of the cylinder, which fit on splines 512 cut on the outside of shaft 508. The splines are parallel to the axis of the shaft 508 so that the thrust sleeve 507 may move axially along the shaft 508 but not rotate with respect to the shaft′ 508. The outside of thrust sleeve 507 carries a thread 513. The thread fits on a matching thread cut on the inside of magnetic rotor component 505, in such a way that axial movement of thrust sleeve 507 causes a rotation of magnetic rotor component 505 around the shaft with respect to magnetic rotor component 506. Thrust bearing 510 prevents axial movement of magnetic rotor component 505, but allows rotation. Thrust bearings 511 and 511′ allow the shaft 508 to rotate in the motor frame (not shown) in the usual way but resist thrust in the axial direction.

1. An electric motor comprising: a stator having a primary winding; a rotor arranged to rotate in the stator and comprising a shaft, a first magnetic rotor component and a second magnetic rotor component, each magnetic rotor component having a magnetic pole of a first polarity and a magnetic pole of a second polarity, at least one of the first and second rotor components further comprising a structure for carrying induced eddy currents, the second magnetic rotor component being rotatable with respect to the first magnetic rotor component around the shaft from an low-flux orientation to an high-flux orientation, the motor being arranged such that the second magnetic rotor component is in the low-flux orientation when the rotor is at rest and is in the high-flux orientation when the rotor is rotating at an operating speed.

2. A motor as claimed in claim 1, in which the magnetic pole of the first polarity of the first rotor component makes an angle of less than 45 degrees electromagnetic with the magnetic pole of the first polarity of the second rotor component in the high-flux orientation.

3. A motor as claimed in claim 2, in which the magnetic pole of the first polarity of the first rotor component makes an angle of less than 1 degree electromagnetic with the magnetic pole of the first polarity of the second rotor component in the high-flux orientation.

4. A motor as claimed in claim 1, in which the magnetic pole of the first polarity of the first rotor component makes an angle of less than 45 degrees electromagnetic with the magnetic pole of the second polarity of the second rotor component in the high-flux orientation.

5. A motor as claimed in claim 4, in which the magnetic pole of the first polarity of the first rotor component makes an angle of less than 1 degree electromagnetic with the magnetic pole of the second polarity of the second rotor component in the high-flux orientation.

6. A motor as claimed in claim 1, which is arranged such that the second magnetic rotor component is in the high-flux orientation when the rotor reaches an operating speed.

7. A motor as claimed in claim 1, in which the second magnetic rotor component is arrestable at an orientation relative to the first magnetic rotor component that is between the low-flux orientation and the high-flux orientation

8. A motor as claimed in claim 1, in which the second magnetic rotor component is rotated relative to the first magnetic rotor component by a centrifugal device.

9. A motor as claimed in claim 8, in which the centrifugal device comprises a latch mounted in a fixed position relative to the first or second magnetic rotor component and a groove situated in a fixed position relative to the other magnetic rotor component, the centrifugal device further comprising an inner slot communicating with an inner edge of the groove and an outer slot communicating with an outer edge of the groove, the inner and outer slots being displaced circumferentially from each other and being arranged to receive the latch, the centrifugal device being arranged such that the latch locks the second magnetic rotor component in the low-flux position at starting and at a predetermined speed the latch moves between the inner slot and the outer slot as the rotor changes its velocity and the circumferential movement of the latch rotates the second magnetic rotor component and locks it relative to the first magnetic rotor component in the high-flux position.

10. A motor as claimed in claim 1, in which the second magnetic rotor component is rotated relative to the first magnetic rotor component by a control motor.

11. A motor as claimed in claim 1, arranged such that the second magnetic rotor component is rotated relative to the first magnetic rotor component when the rotor reaches a selected angular speed.

12. A motor as claimed in claim 1, in which the first magnetic rotor component is fixed to a shaft of the rotor and the second magnetic rotor component rotates relative to the shaft.

13. A motor as claimed in claims claim 1, in which the second magnetic rotor component is fixed to a shaft of the rotor and the first magnetic rotor component rotates relative to the shaft.

14. A motor as claimed in claim 1, in which the first magnetic rotor component or the second magnetic rotor component comprises a plurality of poles of the first polarity and a plurality of poles of the second polarity.

15. A motor as claimed in claim 14, in which the first and the second magnetic rotor component each comprise a plurality of poles of the first. polarity and a plurality of poles of the second polarity.

16. A motor as claimed in claim 1, which is supplied by a multi-phase electricity supply.

17. A motor as claimed in claim 1, which is supplied by a single-phase electricity supply.

18. A machine including a motor according to claim 1.

19. A method of operating an electric motor, comprising: operating a stator having a primary winding and a rotor arranged to rotate in the stator and comprising a shaft and a first magnetic rotor component and a second magnetic rotor component, each magnetic rotor component having a magnetic pole of a first polarity and a magnetic pole of a second polarity and at least one of the first or second rotor components comprising a structure for carrying induced eddy currents, the operation comprising rotating the second magnetic rotor component around the shaft relative to the first magnetic rotor component from an low-flux orientation to an high-flux orientation, such that the second magnetic rotor component is in the low-flux orientation when the rotor is at rest relative to the stator and is in the high-flux orientation when the rotor is rotating at an operating speed.

20. A method as claimed in claim 19, in which the second magnetic rotor component is rotated to the high-flux orientation when the rotor reaches a selected angular speed relative to the stator.

21. A method as claimed in claim 19, in which the second magnetic rotor component is rotated to and arrested at an orientation relative to the first magnetic rotor component that is between the low-flux orientation and the high-flux orientation.

22. A method as claimed in claim 19, in which the second magnetic rotor component is rotated to provide an electric motor with field control so as to vary the supply voltage requirements or output power of the motor.

23. A method of turning off an electromotive machine by rotating a second magnetic rotor component having a pole of a first polarity and a pole of a second polarity relative to a first magnetic rotor component having a pole of the first polarity and a pole of the second polarity.

24. A method as claimed in claim 23, in which the electromotive machine is turned off in response to a fault.

25. A method as claimed in claim 23, in which the electromotive machine is a generator.
